(19) United States
(12) Patent Application Publication
(10) Pub. No.: US 2025/0076870 A1
(43) Pub. Date: Mar. 6, 2025

(54) SMART SENSING FOR WATER AND WASTE SYSTEMS

(71) Applicant: MAG Aerospace Industries, LLC, Carson, CA (US)

(72) Inventors: Nguyen Tram, Chino Hills, CA (US); Deborah Osborne, Redondo Beach, CA (US); Jeffrey Borlik, Carson, CA (US)

(21) Appl. No.: 18/290,196

(22) PCT Filed: Jun. 16, 2022
(86) PCT No.: PCT/US2022/033759

§ 371 Date: Nov. 10, 2023

Related U.S. Application Data
(60) Provisional application No. 63/217,595, filed on Jul. 1, 2021.

(51) Int. Cl. G05B 23/02; B64D 11/02; B64F 5/60

(52) U.S. Cl. CPC G05B 23/0283; B64D 11/02; B64F 5/60

(57) ABSTRACT

Diagnostic monitoring and predictive maintenance recommendations in order to determine whether one or more of the components of the equipment being monitored is in need of repair or replacement. Embodiments also provide for fault detection at the component level, rather than at the overall system level. If a fault is detected or predicted, the component of the system can be maintained, repaired or replaced during scheduled maintenance, rather than removing and replacing the wrong components, multiple components, causing operational interrupts or losing system functionality.

### CROSS REFERENCE TO RELATED APPLICATIONS

This application is related to and claims priority benefits from U.S. Provisional Application Ser. No. 63/217,595, filed on Jul. 1, 2021, entitled “Smart Sensing for Water and Waste Systems and Equipment: Prognostic and Health Management and Augmented Cabin,” the entire contents of which are hereby incorporated in its entirety by this reference.

### FIELD OF THE INVENTION

The field of this disclosure relates to water and waste systems for commercial and military aerospace or other passenger transportation vehicles. Embodiments allow for diagnostic monitoring and predictive maintenance recommendations in order to determine whether one or more of the components of the equipment being monitored is in need of repair or replacement. Embodiments also provide for fault detection at the component level, rather than at the overall system level. If a fault is detected or predicted, the component of the system can be maintained, repaired or replaced during scheduled maintenance, rather than removing and replacing the wrong components, multiple components, causing operational interrupts or losing system functionality.

### BACKGROUND

The advancement of digitization and sensor technology is driving technical discoveries in equipment and system prognostics and health management (PHM), also known as predictive health maintenance, in product design and operating solutions in the aerospace industry. There are established PHM platforms that focus on critical flight systems, such as engines and flight controls. However, there are other systems on board aircraft and other passenger transportation vehicles that can fail and cause serious problems, one example of which is the on-board water and waste system.

Additionally, on-board water and waste systems generally have fault detection at a system level. This means that if a system fails, the failure data will typically indicate only that the entire system has failed, not that a particular component in the system or a working element of a particular component in the system has failed. For example, if an on-board vacuum toilet stops flushing, the fault system will generally indicate a problem with the overall toilet system. However, the fault system typically does not indicate whether the problem is with the toilet flush valve, the vacuum generator, a system leak, a clogged duct, or any other type of specifics about what has caused the failure.

Additionally, when the fault detection system sends an alert about the problem, the failure has already occurred. This can cause a problem if the aircraft is in flight. This can also cause a problem if there is a short turnaround time on ground and engineering personnel are not immediately available to troubleshoot, leading to flight delays.

Accordingly, on-board water and waste systems could benefit from both a more detailed diagnostic/fault detection system, as well as a predictive health maintenance system. The present disclosure thus provides smart sensing for diagnostics and PHM in connection with water and waste equipment and systems on board aircraft and other passenger transportation vehicles. The application of PHM to the disclosed smart sensing of equipment in water and waste systems requires a different set of data analytics and parameters to be monitored, distinct from engines, flight controls, or other industrial applications.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present disclosure provides systems and methods for sensing and monitoring equipment operation in the water and waste system for commercial and military aircraft (or any other passenger transportation vehicle) in order to provide prognostic health management (PHM) for the equipment and the system. Equipment operation is monitored and measured to determine normal and abnormal system operation, detect system and/or equipment faults, and/or to isolate the abnormal operation or faults to specific equipment, and/or to identify failures or potential failures of specific working elements of a component within the system. The PHM system may sense a parameter (or set of parameters) “X” during the operation of the equipment and identify or otherwise detect a potential failure of the equipment based on comparing actual parameter “X” with expected parameter (or set of parameters) “Y.” If the difference between the two parameters exceeds an expected set threshold “T,” a signal can be generated to alert maintenance personnel, either onboard the vehicle or at a maintenance site, that a failure of the equipment is imminent. The disclosure allows for detection and isolation of failures of specific working elements of specific equipment components within the system, rather than only detecting an overall abnormal operation of the water and waste system.

### BRIEF DESCRIPTION OF THE DRAWINGS

FIG. 1 shows a flowchart of diagnostic and predictive health maintenance.

FIG. 2 shows a diagram of failure modes that can be isolated to a system or component or working element level in accordance with this disclosure.

FIG. 3 shows a table of fault isolation, with normal and abnormal operation detection, outlining key sensors to be monitored for various faults, as well as exemplary suggested actions and detection approaches.

FIG. 4 shows various smart components that may be designed for use in connection with the water and waste system and in coordination with this disclosure.

FIG. 5 shows an example of fault detection, showing a difference in key system parameters (waste tank pressure and vacuum generator current flow) from the expected values in a normal non-fault condition compared to the values sensed if the flush valve failed closed.

FIG. 6 shows an example of fault detection, showing a difference in key system parameters (waste tank pressure and vacuum generator current flow) from the expected values in a normal non-fault condition compared to the values sensed if there is a blockage.

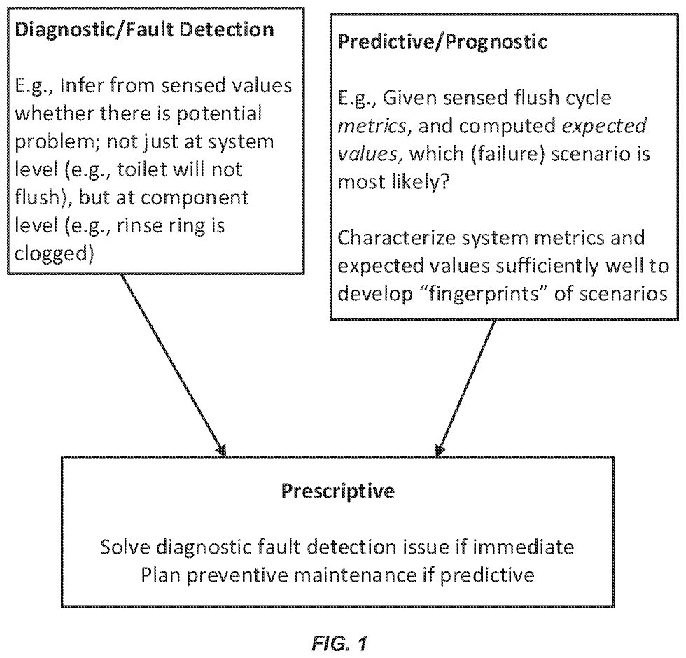

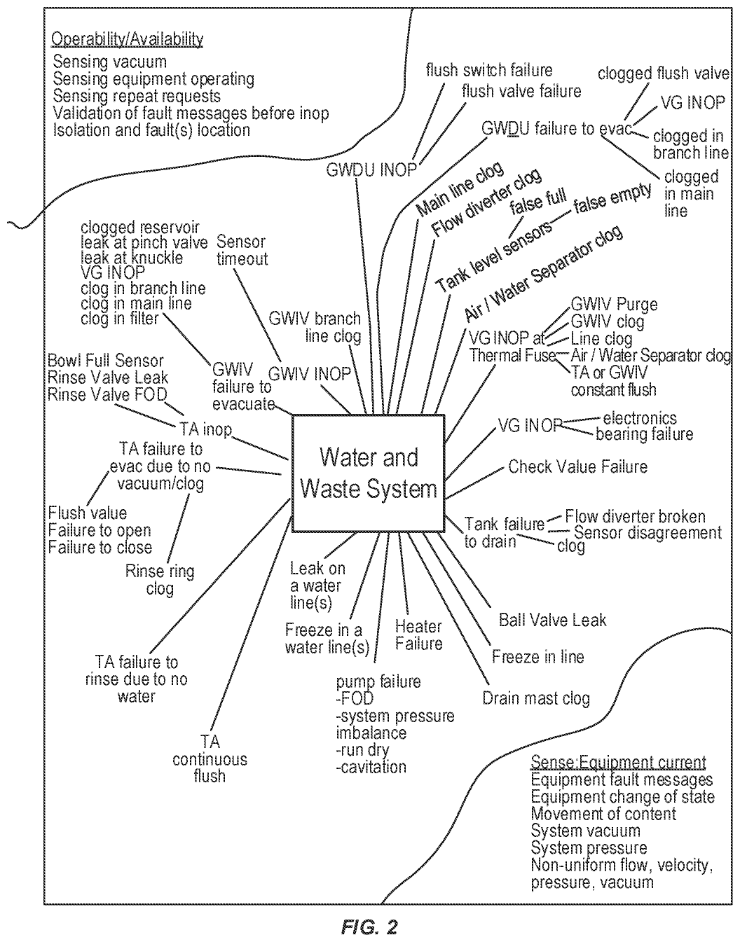

### DETAILED DESCRIPTION

The subject matter of embodiments of the present invention is described herewith specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

The described embodiments of the invention provide a prognostic and health management smart sensing system for water and waste systems on board an aircraft or other passenger transportation vehicle. Although discussed in connection with an aircraft system, the prognostic and health management smart sensing system is by no means so limited. Rather, embodiments of the system may be used in connection with water and waste systems on board other vehicles, such as marine vessels, RVs, trains, or any other instance where a water and waste system would benefit from prognostic health management.

Currently, equipment in the water and waste systems for commercial and military aircraft sometimes fail unexpectedly, resulting in operational interruptions of the water or waste system, potential turn backs of the flight, and unexpected maintenance demands. Additionally, it can be difficult to differentiate which specific equipment in the system has failed, making troubleshooting/fault isolation cumbersome, time consuming, and can contribute to NFF (“no fault found”) removals when additional or incorrect equipment is removed from the aircraft.

Further, the move to more electric aircraft with controls embedded equipment and improved communication enables additional sensing within the equipment or the system. The data available in the monitoring and controls of this equipment is being underutilized in prediction of remaining useful life, in the detection of system operating conditions, and on the optimization of system operation and control. Additional equipment and system sensing can greatly expand the data analytic potential for the water and waste systems, enabling it to be monitored and included in existing or new PHM platforms.

The present disclosure offers solutions for the sensing of equipment and the water and waste system operational condition(s). The sensed condition(s) can be used to both (a) identify a current diagnostic issue/fault detection, as well as to (b) predict remaining useful life of the equipment. The sensed condition(s) can be used to further detect and distinguish/isolate between failure conditions of other equipment and its working elements within the system. The sensed condition(s) can also be used to detect successful or unsuccessful operation of associated equipment or the system.

This disclosure uses on-board sensors, and compares sensed values with expected values, in order to determine proper operation of on-board water and waste systems. Abnormal operation may need to be immediately addressed (fault detection) or anticipated to prevent more severe problems from manifesting (prognostic). This disclosure provides various examples and scenarios for an immediate or predictive sensing. It should be understood that the examples are provided for exemplary purposes only and are not intended to be limiting of the claims. In certain examples, sensor readings may be compared across time. Failures or potential failures may be predicted by considering data collected from multiple operations, or by analyzing trends, particularly for prognostic failures. Particularly meaningful data may be collected via comparison across an ensemble of sensed data and across time of equipment operation. Although specific examples may be described with respect to a single component of equipment or a single working element of an equipment and a single comparison between expected and threshold values, it should be understood that a combination of this analysis will often result in the most robust detection for both immediate fault detection, as well as prognostic health management.

The actions taken may then be one of (1) remove and replace the failed equipment (or equipment for which an imminent failure is predicted) or (2) schedule a future maintenance for the equipment.

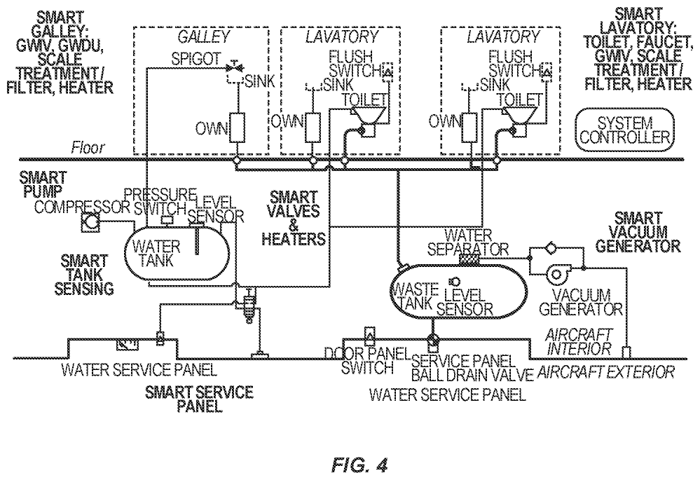

This disclosure provides prognostic health management for various components of a water and waste system. Exemplary components that can be monitored and maintained using the methods and systems described in this disclosure include but are not limited to vacuum generators, air compressors, liquid pumps, toilets (toilet flush valves, rinse valves), various sensors (pressure, vacuum, current, liquid level), liquid separators, water holding tanks, waste holding tanks, heaters, transport elements, grey water evacuation units, galley waste disposal units, valves (of various actuation and control types), or any combination thereof. FIG. 4 illustrates exemplary systems/components in a water and waste system that may be monitored. In a specific example, the disclosed methods and systems monitor the status of a water and waste system, including the individual components within the system, as well as the individual working elements of the individual components within the system. In one embodiment, current performance values are compared against expected performance values in order to determine whether a system fault is likely imminent. If a potential system fault is detected, the component which is showing a predicted likely failure may be repaired or replaced or otherwise addressed before the actual fault occurs. Exemplary performance values that can be monitored in order to detect a potential fault include but are not limited to vibration, electrical current (motor drive current, motor controller input current, heater current), pressure level, humidity, rotational speed, flow, velocity, ventilation, temperature, vacuum level, sensing equipment operation, valve equipment operation, monitoring repeat flush requests, controller output signals, equipment fault messages, combinations of equipment fault messages, equipment change of state, user request commands, or any combination thereof.

### Diagnostic/Fault Isolation

In contrast to the prior methods of simply identifying that a particular system is failing (e.g., a vacuum toilet will not flush), the present disclosure relates to sensing certain specific values on various components of the system on their own, in order to indicate to maintenance personnel specifically where the particular problem is occurring. Accordingly, before removing and replacing the entire system from the vehicle at the system level (e.g., rather than removing and replacing the entire vacuum toilet), the operator may now have more detailed information in order to determine which specific working element of the toilet is expected to fail (or has failed) and should be replaced (e.g., the rinse ring of the vacuum toilet is clogged and should be replaced, with the toilet frame remaining installed).

For example, the observed system effect may be reduced flush performance. A system effect of reduced flush performance may be due to faulty toilet assembly valve, transport line clogging or leaks, inlet diverter fouling, vacuum generator degradation, or other failures. However, making use of key sensor and detection approaches, it is possible to determine more specifically at the component level what has actually caused the failure. These key sensors and detection approaches include comparing sensor values of the tank vacuum pressure, the vacuum generator current draw, vacuum pressure at other locations in the vehicle, other sensors, and those measurements over time on the vehicle. So rather than removing the entire toilet or system, the specific valve or other working element can be repaired or replaced. Similar analysis are outlined in this figure for a grey water interface valve (GWIV), main line, flow diverter, tank level, air water separator, vacuum generator, check valve, tank drain, ball valve, overboard line, drain mast, heaters, pumps, or other types of system leaks.

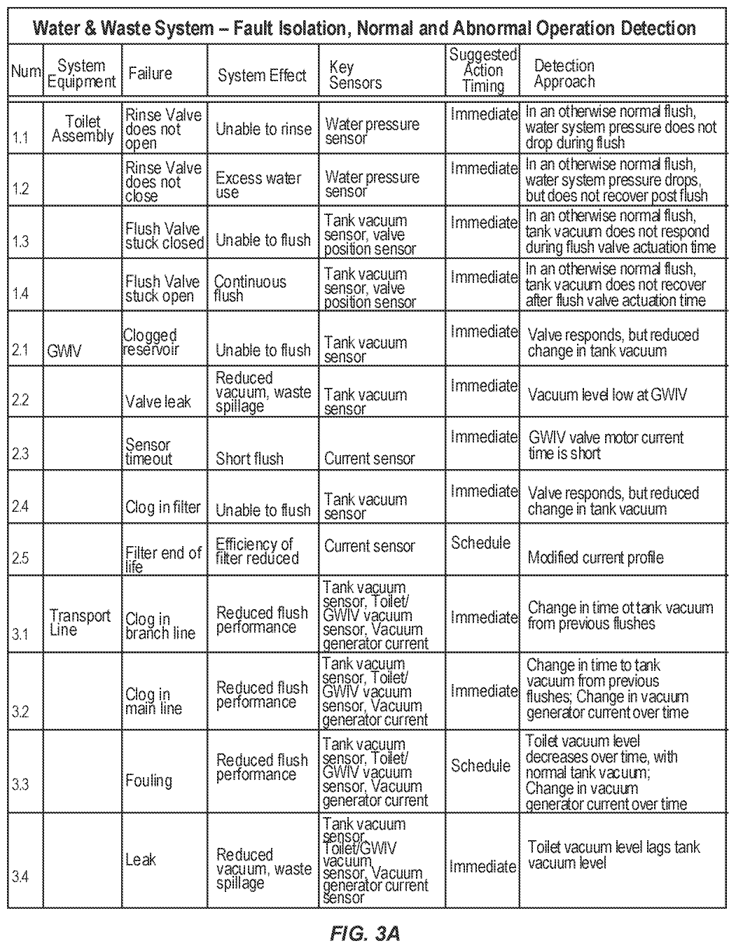

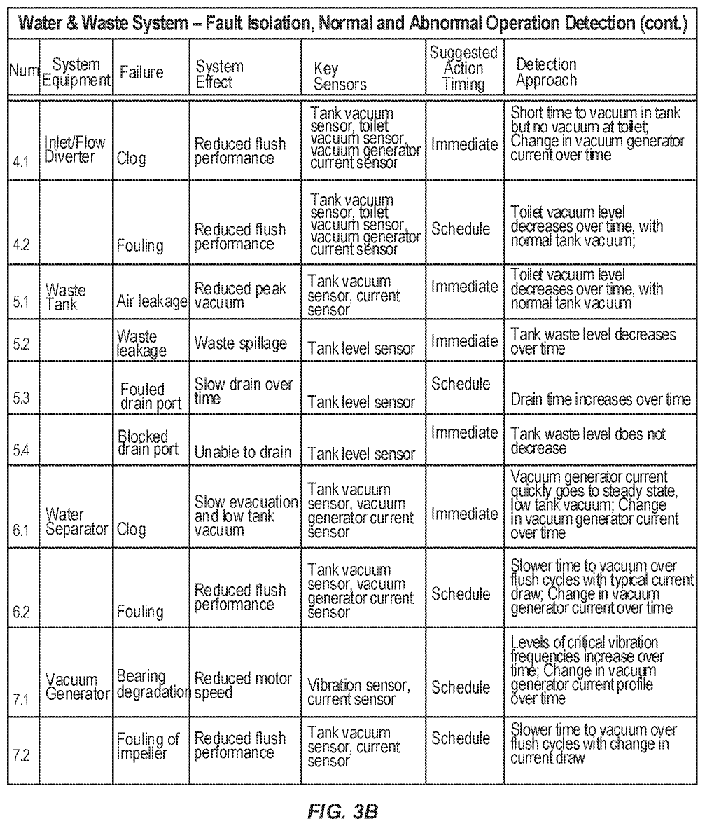

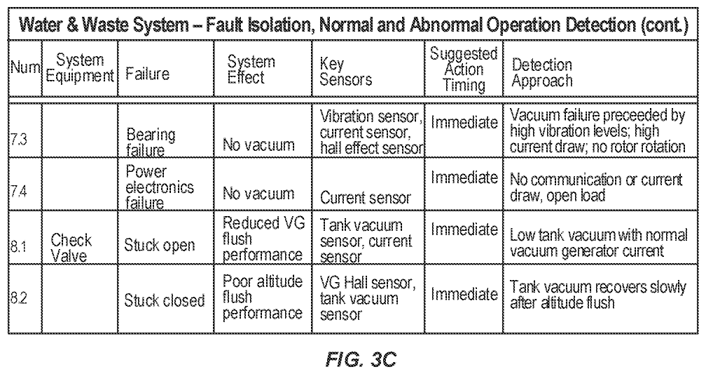

FIG. 3 shows an additional set of examples. In a first example, a toilet assembly may have a rinse valve that is not operating properly. One or more sensors associated with the toilet assembly may be used to diagnose the issue. In an otherwise normal flush, the water system pressure drops during the rinse. If the water pressure does not drop the expected amount, this may signal that the rinse valve is not opening to let water flow, and thus a maintenance action should be raised. Further more detailed examples are provided by FIG. 3. It should be understood that these examples are provided for illustrative purposes only and are not intended to be limiting. Once one of ordinary skill in the art understands the sensing protocol disclosed and that individual components of an entire system can be monitored, other system failures, system effects, and suggested actions/detections may be determined based on data feedback from individual sensors.

FIG. 3 shows further fault isolation detection scenarios that can be used to create fault detection algorithms. For example, at the system/equipment level for the toilet assembly of Row 1, there are a number of different types of failures that may occur (see Failure column) which will result in differing system effects (see System Effect column). These effects may be detected via one or more sensors positioned on various working elements of the smart toilet or system. Examples include but are not limited to a pressure sensors, vacuum sensors, liquid level sensors, valve position sensors, vibration sensors, current sensors, any other appropriate types of sensors, or any combination thereof. Exemplary working elements include but are not limited to the flush valve, rinse valve, rinse ring, main line, drain port, or any combination thereof.

### Predictive/Prognostic

It is also possible to use the sensed data collected from the various individual sensors of the system to predict a potential failure. This aspect of the disclosure uses PHM and analyzes the gradual degradation vs. the immediate degradation of equipment or sensed parameters vs. components that have already failed. In this aspect, the PHM system incorporates (a) characterizations for the baseline performance of all components of the system being monitored and (b) overlays baseline performance over actual collected data. This comparison between measured values and expected values helps predict current and future health of the system.

For example, expected performance parameters of a successful/normal flush may be modeled and a baseline performance can be determined. Relevant parameters can include tank waste volume, tank vacuum, vacuum generator current pull, expected pressure drop between the tank and the vacuum generator, expected time for flush valve to stay open and closed, expected flow rate, expected motor vibration, and any other relevant, tracked parameters. In one example, these parameters can be measured at different times during a flush (e.g., a 1.5 seconds, 3.5 seconds, and 7.5 seconds) in order to compare the differences to an expected baseline. For example, the parameters may be expected tank vacuum, expected rate of change of tank vacuum, and expected vacuum generator current. If there are noticeable/quantifiable differences in performance between the expected scenarios and actual scenarios, an algorithm can be applied to identify the failure scenario. In some implementations, the algorithms are “supervised classification” machine learning algorithms. For example, “decision trees,” which determine a set of questions/criteria to result in a categorization of failure mode. And another example, the algorithm can be “nearest neighbors,” which identify a category of a point that is closest (e.g., Euclidean distance). Other algorithms that match sensor data with expected results are possible. A system can be trained (known data in, known data out), which can lead to a predictive measurement. This disclosure relates to determining the inputs/values to be tested, generating the training data, and interpreting the results.

### Example of Updating Failure Probabilities Over Time.

Monitoring equipment either onboard or on the ground could track the operating state of the equipment, by maintaining a set of probabilities of failures modes.
The state of the equipment (set of failure probabilities) would be initialized to small values determined by analysis of historical failure rates from similar equipment.
For each use of the equipment (e.g. a flush, for vacuum waste systems).
1. Observe the actual sensors values, X
2. Determine expected values, Y, knowing the vehicle operating conditions, given a calibrated model
3. Update the state of failure probabilities based upon the difference between X and Y, taking into account the uncertainty in both sensor measurement and model accuracy. This can be accomplished using algorithms such as Bayes' Theorem.
4. If any of the probabilities are above a determined threshold, T, the difference should be reported. It may take multiple iterations of equipment use (flushes) before different failure scenarios can be distinguished.

### Vacuum Generator

The vacuum generator used on board passenger transportation vehicles, such as aircraft, creates vacuum in the waste tank when commanded by various water and waste system equipment. This generated vacuum evacuates grey and black water or waste from the various equipment (most typically a vacuum toilet, but vacuum sinks may also be installed in the lavatory or galley and can also benefit from the systems of this disclosure) to the waste tank. (Pressure differential may be used in flight for creating vacuum, but when an aircraft is on ground, the vacuum generator is required to provide pressure differential to create a vacuum.) As background, a vacuum generator is a compressor which moves air from sub-ambient volumes to volumes at ambient pressure. Various parameters can be monitored to detect the normal and abnormal operation of the vacuum generator. In one example, it is possible to monitor the overall bearing and/or seal health of the vacuum generator by analyzing vibration levels, which can be calibrated to calculate remaining useful life of the vacuum generator. Self-induced vibration of the vacuum generator can be monitored in order to detect a motor failure or significant rub/ingestion event of the rotating elements. The self-induced vibration can also be used to detect the abnormal operating condition of waste system ingesting water and/or waste. For example, unexpected/normal vibration level of “X” may be compared to the current expected vibration level of “Y,” and if the A (difference) between the two levels is over an acceptable threshold “T,” then a signal can be generated, indicating that a predicted failure is likely, before an actual failure occurs.

In another example, the time expected for a vacuum generator to reach its working speed can be determined. If the vacuum generator takes longer than some threshold (such as a standard deviation) of the expected time to reach its working speed, this is indication of a potential fault or prediction of a future failure. The expected values can be compared to the sensed values in order to identify a current or potential problem.

In another example, the current drawn by the vacuum generator, the resulting waste tank pressures, and/or its temperature may be used to detect/distinguish faults and predictive failure conditions within the system. If a high level or low level of current is detected when not expected, this can indicate a problem in the system. For example, the current drawn by the vacuum generator may be used in combination with additional system communication to further detect and distinguish failure modes of equipment and the system in a similar manner. In another example, humidity within the vacuum generator can be used to detect poor air/water separation and/or abnormal conditions and/or poor maintenance leading to contamination or water/waste ingress into the vacuum generator and adjacent elements.

In another example, rather than simply receiving a notification that there is a problem with the vacuum generator, use of various systems on various portions of the vacuum generator (VG) could instead issue a signal that “VG inlet blocked,” which is representative of a clog somewhere in the waste system meaning that no flow is occurring during the flush cycle. Further sensors may specifically identify problems with individual working elements of the waste system, such as a clog in the main line trunk, a flow diverter or air water separator problem, or other indication.

In a further example, the current drawn by any other component of the system, system vacuum levels and/or the temperature of various components can be monitored to detect normal and abnormal operating conditions of the various equipment in the system and to detect/distinguish faults and failure conditions within the system. Events that may be predicted via such detection/monitoring include but are not limited to a normal evacuation event, a clog in the main trunk line, a clog in a branch line, a clogged air/water separator, a clogged waste tank diverter, clogged monument equipment, and/or broken valves. Various expected values may be assigned to each component in the system, and those expected values can be compared against actual current levels detected/monitored.

### Air Compressors/Pumps

Displacement air compressors or more traditional hydraulic pumps may be used to pressurize the water system and circulate the water from the water tank to the various monuments. Monitoring the self-induced vibration of the air compressors can be used to predict remaining useful life of the air compressor. Monitoring the water system pressure and current draw of the air compressor/pump can be used to detect system leaks or faulty water system equipment Monitoring the self-induced vibration of the pump can be used to detect FOD (foreign object debris) ingestion, water starvation (i.e. zero water level in the system) and remaining useful life of the pump.

### Smart Toilet

As illustrated by the table FIG. 3, this disclosure may also be implemented in connection with a smart toilet assembly and various sensors mounted on different working elements of the toilet. Rather than simply sensing a failure or breakdown of the entire toilet system once it occurs, sensing expected values and comparing them to current values can indicate to an operator that a mechanical and/or electrical fault is predicted (PHM). Additionally or alternatively, sensing current values on their own, apart from PHM, can indicate to maintenance personnel where the particular problem is occurring. In either instance, before removing and replacing the entire toilet from the vehicle at the system level, the operator may now have more detailed information in order to determine which specific working element of the toilet is expected to fail (or has failed) and should be replaced.

For predictive health maintenance (PHM) in connection with the smart toilet example, an expected water pressure sensor reading “Y1” and an expected tank vacuum sensor reading “Y2” would be identified. Then, the actual sensed water pressure sensor reading “X1” and the actual sensed tank vacuum sensor reading “X2” would be compared with the expected readings earlier identified. The system would run an algorithm to compare the expected readings with the actual readings and determine the difference (Δ1 or Δ2) there between. The difference (Δ1 or Δ2) is then compared with a PHM threshold for that particular sensor (T1 or T2) in order to determine whether the threshold has been exceeded.

### Smart Toilet Flush Valve Example

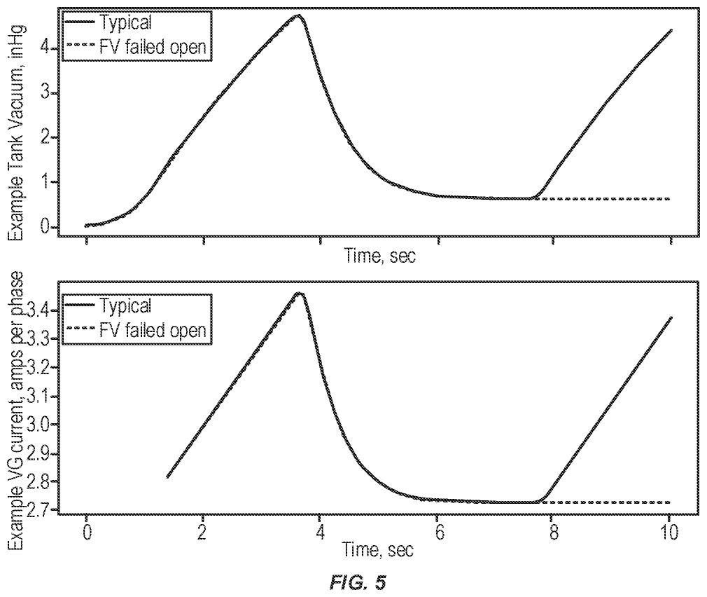

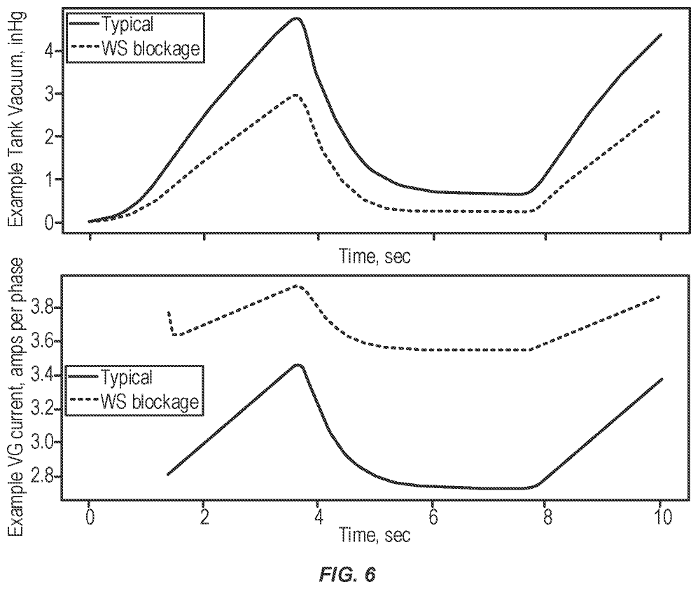

In a Smart Toilet, the flush valve can potentially be stuck open, and the application of Smart Sensing can be used to detect and/or predict this. As an example, consider a typical system which may have a model calibrated to calculate expected vacuum levels at +/−0.75 inHg, and onboard vacuum sensors that can read +/−0.25 inHg. The initial “probability flush valve is stuck open” may be determined from historical reliability data as 1e-6 occurrences per use. Suppose, given the vehicle operating conditions, the model predicts that the value of vacuum sensor should be “p≥3.0 in Hg at t=9.0 sec of the flush cycle” for normal operation, and “p≤0.5 inHg at t=9.0 sec of the flush cycle” if the valve had failed. FIG. 5 depicts the predicted performance of the system under normal operation or if the flush valve was stuck open. If the vacuum sensor detects an actual vacuum level of “p=0.8 inHg at t=9.0 sec of the flush cycle”, then the probability that the valve has failed open can be increased (using well-known statistical rules such as Bayes Theorem). In this case, given the uncertainties in the model and the measurement, the new probability that the valve is stuck open is 0.913. Under this analysis, a warning should be made due to the values detected as compared to the values expected, but under other circumstances, if the probability was below the threshold for warning, the value could be stored until the next flush to await further data. Various other examples that could indicate PHM issues include but are not limited to:
a flush request followed by no change in system water pressure could indicate a clog in that particular rinse ring; or
a flush request followed by no change in system vacuum pressure and without a flush valve failure to open message could indicate a clog in the main line or flow diverter; or
a flush request followed by a continued reduction in system water pressure after the flush could indicate foreign object debris (FOD) in the rinse valve (rinse valve stuck open) or failure of the rinse valve components; or
a flush request followed by failure to regenerate vacuum in the waste tank and failure for flush valve to close message could indicate a clog in the flush valve.

### Air/Water Separator

A further example for which this disclosure can help predict failure is in connection with an air/water separator. In a normal working system, the air/water separator will require a baseline of current from a vacuum generator as it goes through its cycle (in order for it to create the required vacuum in the water tank). If the vacuum generator gradually increases current, this is an indication of a potential problem with the air/water separator.

### Other Aircraft Applications

The above examples of the equipment that can be monitored for PHM capability describe detection and isolation of equipment and system operational and fault conditions. Although described with respect to the on-board water and waste system, similar applications of smart sensing and extension to system operational/fault isolation capability can be applied to other aircraft systems. For example, this disclosure may apply to a fuel pump/fuel system, ventilation fan/environmental control systems, or any other appropriate components that may need to be (or can be) monitored for predictive health maintenance. For example, fuel pump characteristic performance may be able to detect fault conditions of adjacent fuel system equipment. In this instance, the parameters monitored and algorithms defined would be specific to the operating conditions and sensitivities of the fuel pump and fuel system.

It is possible for a sensor to sense pressure differential across various components and equipment; to sense non-uniform vacuum, pressure, velocity (these parameters may be used to detect clogs); to sense content moving through the transport elements into the tank (these parameters may be used to detect clogs and/or confirm equipment operation); to sense water pressure (this parameter may be used to detect water leaks or a pump failure); to sense vacuum generation in the tank and/or vacuum generation in the transport elements (these parameters may be used to detect usage and isolate clogs).

In one example, a flush command (on a toilet in a particular lavatory) on ground which results in short time to vacuum (but no change in vacuum at t=3 sec when the flush valve should open) indicates a clog in the main line or flow diverter.

In another example, a grey water interface valve (GWIV) flush command which results in constant vacuum across the time duration for the GWIV flush and with a toilet flush at the same lavatory within the ˜last 10 minutes which generated the typical vacuum profile in the tank could indicate a clog in the GWIV branch line or the GWIV. Whereas the acceptable toilet flush followed by triple request of GWIV to evacuate and low vacuum at GWIV could indicate a tear in the GWIV pinch valve/leak in the reservoir.

In another example implementation of diagnostic and predictive health monitoring, the monitored behavior deviating from anticipated behavior expected from normal and abnormal user interaction with the system can be indicative of component failure or adjacent system component failure. Smart equipment can then render themselves temporarily inoperative to prevent propagation of damage or alarming equipment behavior. Annunciation of the deviated behavior can assist in diagnosis and repair of adjacent sub-system equipment. For example, a faulty motion activated flush switch may trigger the toilet assembly to constantly flush leading to offensive noise and early wear out of the toilet assembly flush valve or vacuum generator, as well as depletion of potable water. In this example, a sudden increase in toilet evacuation requests can be overridden by temporarily deactivating the associated toilet assembly. Similarly, a lavatory GWIV having normal evacuation behavior, but with repeated evacuation requests could be indicative of a failure of the valve in the faucet leading to offensive noise and early wear out of the vacuum generator as well as depletion of potable water. In this example, the repeated GWIV flush requests timed with the flowrate of the faucet can be overridden by temporarily restricting water to the associated lavatory faucet.

This disclosure can help maximize operability of subsystems by using second and third Equipment Level data for PHM. For example, as illustrated by FIG. 3, instead of using data at Level 1 (e.g., toilet failure or toilet failure predicted), the system can use data at Level 2 and/or Level 3 to isolate potential problems of specific working elements more specifically. This can help ease operations for onboard and ground crews in order to determine which components are candidates for repair and replace and/or which components may need just a single internal working element repaired/replaced. By predicting near end life of equipment based on operating conditions, it is possible to prevent operational interruptions, improve logistics around maintenance, drive efficiency and repair stations, provide long-term refinement of equipment design, reduce turnaround time to avoid flight delays and cancellations, isolate failure causes and limit repairs, reduce repair costs, and help avoid subsequent failures. Other advantages of this disclosure are that it can help identify problems before they become immediate. For example, if time for flush valve increases gradually over time, this can be indicative of motor drive wear out. Increasing vibration levels of pump or vacuum generators can be indicative of bearing wear out. Time to pressurize the water system can be indicative of pump bearing wear out or an air compressor in-take filter clog. Gradual increase in time to vacuum in the waste tank (for a given monument location) can be indicative of Air/Water separator fouling/clog over time vs immediate faster time to vacuum in the waste tank is indicative of a clog in the flow diverter.

In the following, further examples are described to facilitate the understanding of the invention:

Example A. In one example, there is provided a method for diagnostic and predictive health management for a vehicle water and waste system, comprising:
(a) providing one or more sensors associated with one or more components of the water and waste system;
(b) collecting at least one actual sensed value (X1) from at least one of the one or more sensors;
(c) comparing the sensed value with an expected value (Y1) for the component from which the sensed value was collected;
(d) determining a Δ difference between the sensed value and the expected value (Δ1);
(e) comparing the Δ difference to a predetermined threshold value (T); and
(f) if the predetermined threshold value (T) is exceeded by the Δ difference, recommending scheduling preventive maintenance or replacing or repairing the one or more components from which the sensed value was collected.

Example B. The method of any of the preceding or subsequent examples, further comprising the one or more sensors comprising pressure sensors, vacuum sensors, liquid level sensors, valve position sensors, vibration sensors, current sensors, or any combination thereof.

Example C. The method of any of the preceding or subsequent examples, further comprising wherein the one or more components of the water and waste system comprise a rinse valve, a flush valve, a pinch valve, a reservoir line, a vacuum tank, a vacuum generator, an air compressor, a transport line, a branch line, a water separator, a check valve, a water tank, a water pump, a toilet assembly, or any combination thereof.

Example D. The method of any of the preceding or subsequent examples, further comprising wherein the at least one actual sensed value (X1) from at least one of the one or more sensors comprises a plurality of sensed values over a set period of time.

Example E. The method of any of the preceding or subsequent examples, further comprising wherein the at least one actual sensed value (X1) from at least one of the one or more sensors comprises a plurality of sensed values from a plurality of sensor components.

Example F. The method of any of the preceding or subsequent examples, wherein the vehicle comprises an aircraft.

Example G. A further example provides a method for determining failure or fault of a working element at a component level instead of at a system-level or at subsystem-level for a vehicle water and waste system, wherein the water and waste system is comprised of a plurality of equipment components, wherein each component is comprised of a plurality of working elements:
(a) providing at least one fault detection approach for at least one component failure mode under consideration;
(b) collecting sensed values (X) from that at least one fault detection approach;
(c) comparing one or more collected sensed values (X) with one or more expected values (Y) for the working element from which the one or more collected sensed values were collected;
(d) determining a Δ difference between the one or more collected sensed values and the one or more expected values (Δ);
(e) comparing the Δ difference to a predetermined threshold value (T); and
(f) if the predetermined threshold value (T) is exceeded by the Δ difference, recommending scheduling preventive maintenance or replacing or repairing the working element of the component rather than removing and replacing the entire component from the water and waste system.

Example H. The method of any of the preceding or subsequent examples, wherein the component comprises a vacuum toilet and wherein the plurality of working elements comprise a rinse valve, an anti-syphon valve, a flush valve, a rinse ring, or any combination thereof.

Example I. The method of any of the preceding or subsequent examples, wherein the component comprises a vacuum generator and wherein the plurality of working elements comprise a rotating group, electronic circuits, an impeller, an auxiliary fan(s), or any combination thereof.

Example J. The method of any of the preceding or subsequent examples, wherein the component comprises a pump and wherein the plurality of working elements comprise a rotating group, electronic circuits, an impeller, a check valve, or any combination thereof.

Example K. The method of any of the preceding or subsequent examples, wherein the component comprises an air compressor and wherein the plurality of working elements comprise a rotating group(s), a pressure chamber, an inlet filter, a valve, an auxiliary fan(s), or any combination thereof.

Example L. The method of any of the preceding or subsequent examples, wherein the component comprises a grey water interface valve and wherein the plurality of working elements comprises a reservoir, a filter, a valve, or any combination thereof.

Example M. The method of any of the preceding or subsequent examples, wherein the component comprises a galley waste disposal unit and wherein the plurality of working elements comprises a reservoir, a flush valve, a rinse valve, an actuation switch, or any combination thereof.

Example N. The method of any of the preceding or subsequent examples, wherein the component comprises a waste tank assembly and wherein the plurality of working elements comprises a pressure vessel, an air/waste water separator, a level sensor(s), or any combination thereof.

Example O. The method of any of the preceding or subsequent examples, wherein the component comprises a water tank assembly and wherein the plurality of working elements comprises a pressure vessel, a valve, a level sensor(s), or any combination thereof.

Example P. The method of any of the preceding or subsequent examples, wherein collecting one or more sensed values (X) from each of the at least one fault detection approaches comprises a plurality of sensed values over a set period of time.

Example Q. The method of any of the preceding or subsequent examples, wherein collecting one or more sensed values (X) from each of the at least one fault detection approaches comprises a plurality of sensed values from one or more working elements of the component.

Example R. The method of any of the preceding or subsequent examples, wherein the at least one fault detection approach comprises at least one sensor associated with at least one working component.

Example S. There is further provided a method for determining failure or fault of a working element at a component level instead of at a system-level or subsystem-level for a vehicle water and waste system, wherein the water and waste system is comprised of a plurality of equipment components, wherein each component is comprised of a plurality of working elements:
(a) sensing a plurality of component responses against a rule of expected system responses;
(b) collecting the plurality of component responses;
(c) isolating failure of the component or the working element or both; and
(d) recommending scheduling preventive maintenance or replacing or repairing the one or more working elements or components or both from which the component responses were collected.

It should be understood that different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

1. A method for diagnostic and predictive health management for a vehicle water and waste system, comprising:
(a) providing one or more sensors associated with one or more components of the water and waste system;
(b) collecting at least one actual sensed value (X1) from at least one of the one or more sensors;
(c) comparing the sensed value with an expected value (Y1) for the component from which the sensed value was collected;
(d) determining a Δ difference between the sensed value and the expected value (Δ1);
(e) comparing the Δ difference to a predetermined threshold value (T); and
(f) if the predetermined threshold value (T) is exceeded by the Δ difference, recommending scheduling preventive maintenance or replacing or repairing the one or more components from which the sensed value was collected.

2. The method of claim 1, wherein the one or more sensors comprise pressure sensors, vacuum sensors, liquid level sensors, valve position sensors, vibration sensors, current sensors, or any combination thereof.

3. The method of claim 1, wherein the one or more components of the water and waste system comprise a rinse valve, a flush valve, a pinch valve, a reservoir line, a vacuum tank, a vacuum generator, an air compressor, a transport line, a branch line, a water separator, a check valve, a water tank, a water pump, a toilet assembly, or any combination thereof.

4. The method of claim 1, wherein the at least one actual sensed value (X1) from at least one of the one or more sensors comprises a plurality of sensed values over a set period of time.

5. The method of claim 1, wherein the at least one actual sensed value (X1) from at least one of the one or more sensors comprises a plurality of sensed values from a plurality of sensor components.

6. The method of claim 1, wherein the vehicle comprises an aircraft.

7. A method for determining failure or fault of a working element at a component level instead of at a system-level or at subsystem-level for a vehicle water and waste system, wherein the water and waste system is comprised of a plurality of equipment components, wherein each component is comprised of a plurality of working elements:
(a) providing at least one fault detection approach for at least one component failure mode under consideration;
(b) collecting sensed values (X) from that at least one fault detection approach;
(c) comparing one or more collected sensed values (X) with one or more expected values (Y) for the working element from which the one or more collected sensed values were collected;
(d) determining a Δ difference between the one or more collected sensed values and the one or more expected values (Δ);
(e) comparing the Δ difference to a predetermined threshold value (T); and
(f) if the predetermined threshold value (T) is exceeded by the Δ difference, recommending scheduling preventive maintenance or replacing or repairing the working element of the component rather than removing and replacing the entire component from the water and waste system.

8. The method of claim 7, wherein the component comprises a vacuum toilet and wherein the plurality of working elements comprise a rinse valve, an anti-syphon valve, a flush valve, a rinse ring, or any combination thereof.

9. The method of claim 7, wherein the component comprises a vacuum generator and wherein the plurality of working elements comprise a rotating group, electronic circuits, an impeller, an auxiliary fan(s), or any combination thereof.

10. The method of claim 7, wherein the component comprises a pump and wherein the plurality of working elements comprise a rotating group, electronic circuits, an impeller, a check valve, or any combination thereof.

11. The method of claim 7, wherein the component comprises an air compressor and wherein the plurality of working elements comprise a rotating group(s), a pressure chamber, an inlet filter, a valve, an auxiliary fan(s), or any combination thereof.

12. The method of claim 7, wherein the component comprises a grey water interface valve and wherein the plurality of working elements comprises a reservoir, a filter, a valve, or any combination thereof.

13. The method of claim 7, wherein the component comprises a galley waste disposal unit and wherein the plurality of working elements comprises a reservoir, a flush valve, a rinse valve, an actuation switch, or any combination thereof.

14. The method of claim 7, wherein the component comprises a waste tank assembly and wherein the plurality of working elements comprises a pressure vessel, an air/waste water separator, a level sensor(s), or any combination thereof.

15. The method of claim 7, wherein the component comprises a water tank assembly and wherein the plurality of working elements comprises a pressure vessel, a valve, a level sensor(s), or any combination thereof.

16. The method of claim 7, wherein collecting one or more sensed values (X) from each of the at least one fault detection approaches comprises a plurality of sensed values over a set period of time.

17. The method of claim 7, wherein collecting one or more sensed values (X) from each of the at least one fault detection approaches comprises a plurality of sensed values from one or more working elements of the component.

18. The method of claim 7, wherein the at least one fault detection approach comprises at least one sensor associated with at least one working component.

19. A method for determining failure or fault of a working element at a component level instead of at a system-level or subsystem-level for a vehicle water and waste system, wherein the water and waste system is comprised of a plurality of equipment components, wherein each component is comprised of a plurality of working elements:
(a) sensing a plurality of component responses against a rule of expected system responses;
(b) collecting the plurality of component responses;
(c) isolating failure of the component or the working element or both; and
(d) recommending scheduling preventive maintenance or replacing or repairing the one or more working elements or components or both from which the component responses were collected.
